(19) United States
(12) Patent Application Publication
(10) Pub. No.: US 2023/0290948 A1
(43) Pub. Date: Sep. 14, 2023

(54) SECONDARY BATTERY

(71) Applicant: Prime Planet Energy & Solutions, Inc., Tokyo (JP)

(72) Inventors: Yuta MATSUO, Kobe-shi (JP); Kunihiko HAYASHI, Miki-shi (JP); Masumi TERAUCHI, Koriyama-shi (JP)

(21) Appl. No.: 18/180,853

(22) Filed: Mar. 9, 2023

(30) Foreign Application Priority Data
Mar. 11, 2022 (JP) 2022-038501

(51) Int. Cl. H01M 4/587; H01M 4/133

(52) U.S. Cl. CPC H01M 4/587; H01M 4/133; H01M 2004/021

(57) ABSTRACT

A secondary battery disclosed herein includes a negative electrode including a negative electrode core body and a negative electrode active material layer formed on the negative electrode core body and including a negative electrode active material. The negative electrode active material layer has, in a Log differential pore volume distribution obtained by a mercury intrusion method, a first peak P1 and a second peak P2 with a larger pore diameter than the first peak P1 in a range where a pore diameter is 0.50 μm or more and 6.00 μm or less. The pore volume of pores corresponding to the first peak P1 is 6 mL/g or more.

### CROSS REFERENCE TO RELATED APPLICATION

This application claims the benefit of priority to Japanese Patent Application No. 2022-038501 filed on Mar. 11, 2022. The entire contents of this application are hereby incorporated herein by reference.

### BACKGROUND OF THE DISCLOSURE

### 1. Field

The present application relates to a secondary battery.

### 2. Background

Secondary batteries such as nonaqueous electrolyte secondary batteries have been required to have higher performance along with the spread. In recent years, examinations have been conducted on increasing the density of a negative electrode from the viewpoint of improving energy density. Increasing the density of the negative electrode, however, results in crush of negative electrode active material particles to reduce the space between the particles and accordingly, impregnation with an electrolyte solution becomes difficult. In regard to this, for example in WO 2021/044482, the liquid absorbing property of a negative electrode with the increased density is improved by regulating a pore distribution in the negative electrode. Conventional technical literatures related to the negative electrode include Japanese Patent Application Publication No. 2016-009651, Japanese Patent No. 5246747, Japanese Patent No. 5673690, Japanese Patent No. 5787196, and Japanese Patent No. 6120382.

### SUMMARY

According to examinations by the present inventors, however, it has been difficult for the aforementioned techniques to achieve both the productivity in battery production and the increase in energy density corresponding to one performance index in designing the negative electrode at a high level. That is to say, the negative electrode with the increased density still has a problem that, in a liquid injection step in the battery production, impregnation takes long and the liquid injection tact time is long.

The present application has been made in view of the above circumstances and a main object of the present application is to provide a secondary battery including a negative electrode that is excellent in impregnation with a nonaqueous electrolyte solution.

A secondary battery according to the present application includes an electrode body including a positive electrode and a negative electrode, a nonaqueous electrolyte solution, and a battery case that accommodates the electrode body and the nonaqueous electrolyte solution. The negative electrode includes a negative electrode core body, and a negative electrode active material layer formed on the negative electrode core body and including a negative electrode active material. In a Log differential pore volume distribution obtained by a mercury intrusion method, the negative electrode active material layer has a first peak and a second peak, which exists on the side where a pore diameter is larger than that at the first peak, in a range where the pore diameter is 0.50 μm or more and 6.00 μm or less. The pore volume of pores corresponding to the first peak is 6 mL/g or more.

In the present application, the first peak exists in the range where the pore diameter is 0.50 to 6.00 μm and the pore volume is the predetermined volume or more; therefore, the nonaqueous electrolyte solution can be spread quickly to the inside of the negative electrode active material layer, particularly even to a deep part far from the surface, by using a capillary phenomenon. In addition, by the existence of the second peak with the relatively large pore diameter in the range where the pore diameter is 0.50 to 6.00 μm, the amount of spaces in the negative electrode active material layer is increased and the contact angle on the nonaqueous electrolyte solution is reduced, so that the wettability can be improved. Accordingly, by the two peaks as described above, the liquid absorbing speed of the nonaqueous electrolyte solution can be improved and the impregnation of the negative electrode active material layer with the nonaqueous electrolyte solution can be improved. Thus, the liquid injection tact time can be shortened and the productivity of the battery can be improved.

The above and other elements, features, steps, characteristics and advantages of the present application will become more apparent from the following detailed description of the preferred embodiments with reference to the attached drawings.

### BRIEF DESCRIPTION OF THE DRAWINGS

FIG. 1 is a perspective view schematically illustrating a battery according to an embodiment;

FIG. 2 is a schematic longitudinal cross-sectional view taken along line II-II in FIG. 1;

FIG. 3 is a perspective view schematically illustrating an electrode body group attached to a sealing plate;

FIG. 4 is a perspective view schematically illustrating one electrode body;

FIG. 5 is a schematic view illustrating a structure of the electrode body;

FIG. 6 is a cross-sectional view schematically illustrating a structure of a negative electrode;

FIG. 7 illustrates one example of a Log differential pore volume distribution obtained by a mercury intrusion method; and

FIG. 8 illustrates Log differential pore volume distributions in Examples 1 to 3 and Comparative Examples 1 and 4.

### DETAILED DESCRIPTION OF THE PREFERRED EMBODIMENTS

Preferred embodiments of the art disclosed herein will be described below with reference to the drawings. Incidentally, matters other than matters particularly mentioned in the present specification and necessary for the implementation of the present application (for example, the general configuration and manufacturing process of a battery that do not characterize the present invention) can be grasped as design matters of those skilled in the art based on the prior art in the relevant field. The present invention can be implemented on the basis of the disclosure of the present specification and common technical knowledge in the relevant field. In the present specification, the notation “A to B” for a range signifies a value more than or equal to A and less than or equal to B, and is meant to encompass also the meaning of being “preferably more than A” and “preferably less than B”.

In the present specification, the term “secondary battery” refers to general power storage devices that are capable of being charged and discharged repeatedly, and corresponds to a concept encompassing so-called storage batteries such as lithium ion secondary batteries and nickel-hydrogen batteries, and capacitors such as electrical double-layer capacitors.

<Secondary Battery 100>

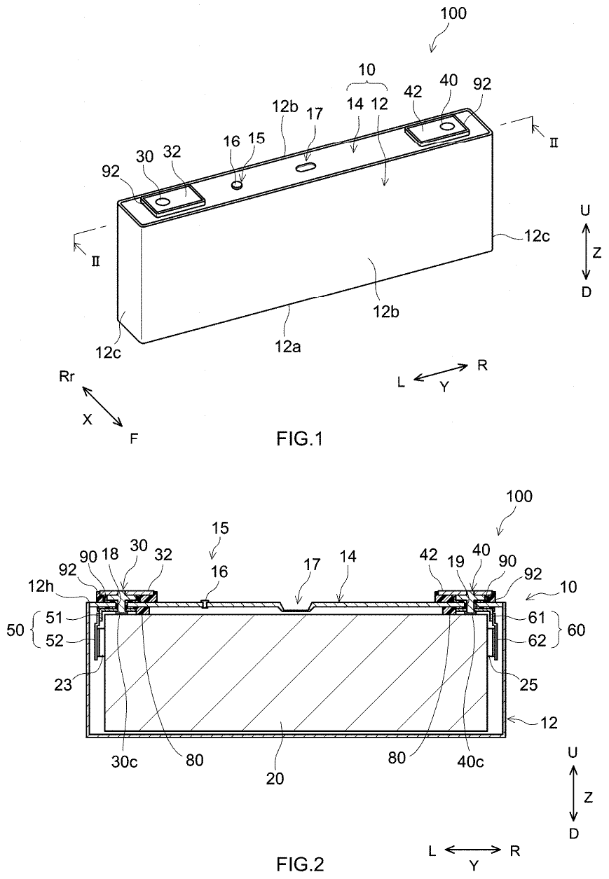

FIG. 1 is a perspective view of a secondary battery 100, and FIG. 2 is a schematic longitudinal cross-sectional view taken along line II-II in FIG. 1. In the following description, reference signs L, R, F, Rr, U, and D in the drawings respectively denote left, right, front, rear, up, and down, and reference signs X, Y, and Z in the drawings respectively denote a short side direction of the secondary battery 100, and a long side direction and an up-down direction thereof that are orthogonal to the short side direction. These directions are defined however for convenience of explanation, and do not limit the manner in which the secondary battery 100 is disposed.

As illustrated in FIG. 2, the secondary battery 100 includes a battery case 10, an electrode body group 20, a positive electrode terminal 30, a negative electrode terminal 40, a positive electrode current collecting part 50, a negative electrode current collecting part 60, and a nonaqueous electrolyte solution (not shown). The secondary battery 100 is a lithium ion secondary battery here.

The battery case 10 is a housing that accommodates the electrode body group 20 and the nonaqueous electrolyte solution. The external shape of the battery case 10 here is a flat and bottomed cuboid shape (rectangular shape). The shape of the battery case 10 may alternatively be a cylindrical shape, a bag-like shape, or the like. A conventionally used material can be used for the battery case 10, without particular limitations. The battery case 10 is preferably made of a metal, and for example, more preferably made of aluminum, aluminum alloy, iron, iron alloy, or the like. The battery case 10 may be an aluminum laminate film including a metal layer containing aluminum and a fusion layer containing resin. As illustrated in FIG. 2, the battery case 10 includes an exterior body 12 having an opening 12h, and a sealing plate (lid body) 14 that seals the opening 12h. The battery case 10 preferably includes the exterior body 12 having the opening 12h and the sealing plate 14 that seals the opening 12h as described in the present embodiment.

As illustrated in FIG. 1, the exterior body 12 includes a bottom wall 12a, a pair of long side walls 12b extending from the bottom wall 12a and opposing each other, and a pair of short side walls 12c extending from the bottom wall 12a and opposing each other. The bottom wall 12a is substantially rectangular in shape. The bottom wall 12a opposes the opening 12h. The short side wall 12c is smaller in area than the long side wall 12b. The sealing plate 14 is attached to the exterior body 12 so as to cover the opening 12h of the exterior body 12. The sealing plate 14 opposes the bottom wall 12a of the exterior body 12. The sealing plate 14 is substantially rectangular in shape in a plan view. The battery case 10 is unified in a manner that the sealing plate 14 is joined (for example, joined by welding) to a periphery of the opening 12h of the exterior body 12. The battery case 10 is hermetically sealed (closed).

As illustrated in FIG. 2, a liquid injection hole 15, a gas discharge valve 17, and two terminal extraction holes 18 and 19 are provided in the sealing plate 14. The liquid injection hole 15 is provided for the purpose of injecting the nonaqueous electrolyte solution after the sealing plate 14 is assembled to the exterior body 12. The liquid injection hole 15 is sealed by a sealing member 16. The gas discharge valve 17 is configured to break when the pressure in the battery case 10 becomes more than or equal to a predetermined value so as to discharge the gas out of the battery case 10. The terminal extraction holes 18 and 19 are formed on opposite end parts of the sealing plate 14 in the long side direction Y. The terminal extraction holes 18 and 19 penetrate the sealing plate 14 in the up-down direction Z. The terminal extraction holes 18 and 19 each have the inner diameter that enables the positive electrode terminal 30 and the negative electrode terminal 40, which have not been attached to the sealing plate 14 yet (before a caulking process), to pass therethrough.

The nonaqueous electrolyte solution may be similar to the conventional nonaqueous electrolyte solution, without particular limitations. The nonaqueous electrolyte solution contains a nonaqueous solvent and a supporting salt (electrolyte salt). The nonaqueous electrolyte solution may additionally contain an additive as necessary. Examples of the nonaqueous solvent include carbonates such as ethylene carbonate, dimethyl carbonate, and ethyl methyl carbonate. The nonaqueous solvent preferably contains carbonates, particularly cyclic carbonates and chained carbonates. Examples of the supporting salt include fluorine-containing lithium salts such as lithium hexafluorophosphate (LiPF₆).

The positive electrode terminal 30 is disposed at an end part of the sealing plate 14 on one side in the long side direction Y (left end part in FIG. 1 and FIG. 2). The negative electrode terminal 40 is disposed at an end part of the sealing plate 14 on the other side in the long side direction Y (right end part in FIG. 1 and FIG. 2). As illustrated in FIG. 2, the positive electrode terminal 30 and the negative electrode terminal 40 extend from the inside to the outside of the sealing plate 14 through the terminal extraction holes 18 and 19. The positive electrode terminal 30 and the negative electrode terminal 40 are fixed to the sealing plate 14. The positive electrode terminal 30 and the negative electrode terminal 40 are here caulked to a peripheral part of the sealing plate 14 that surrounds the terminal extraction holes 18 and 19 by the caulking process. Caulking parts 30c and 40c are formed at an end part of the positive electrode terminal 30 and the negative electrode terminal 40 on the exterior body 12 side (lower end part in FIG. 2).

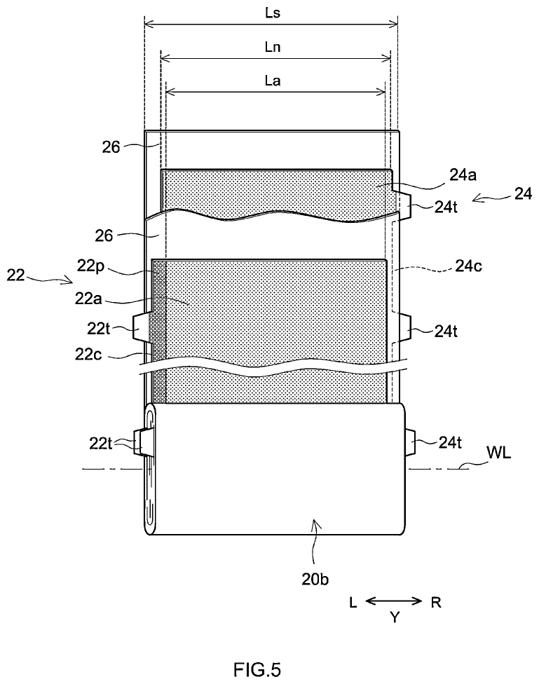

As illustrated in FIG. 2, the positive electrode terminal 30 is electrically connected to a positive electrode 22 (see FIG. 5) of the electrode body group 20 through the positive electrode current collecting part 50 inside the exterior body 12. The negative electrode terminal 40 is electrically connected to a negative electrode 24 (see FIG. 5) of the electrode body group 20 through the negative electrode current collecting part 60 inside the exterior body 12. The positive electrode terminal 30 is insulated from the sealing plate 14 by an internal insulation member 80 and a gasket 90. The negative electrode terminal 40 is insulated from the sealing plate 14 by the internal insulation member 80 and the gasket 90.

A positive electrode external conductive member 32 and a negative electrode external conductive member 42, each having a plate shape, are attached to an external surface of the sealing plate 14. The positive electrode external conductive member 32 is electrically connected to the positive electrode terminal 30. The negative electrode external conductive member 42 is electrically connected to the negative electrode terminal 40. The positive electrode external conductive member 32 and the negative electrode external conductive member 42 are members to which a busbar is attached when a plurality of the secondary batteries 100 are connected to each other electrically. The positive electrode external conductive member 32 and the negative electrode external conductive member 42 are insulated from the sealing plate 14 by an external insulation member 92.

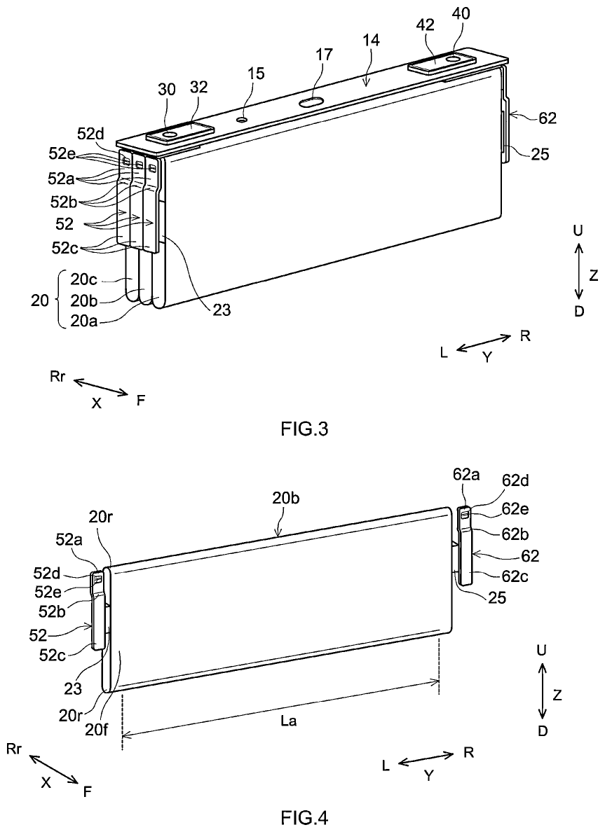

FIG. 3 is a perspective view schematically illustrating the electrode body group 20 attached to the sealing plate 14. The electrode body group 20 includes a plurality of electrode bodies. The electrode body group 20 here includes three electrode bodies 20a, 20b, and 20c. The number of electrode bodies to be disposed in one exterior body 12 is, however, not limited in particular and may be two, or four or more. The electrode bodies 20a, 20b, and 20c are electrically connected to each other in parallel here. The electrode bodies 20a, 20b, and 20c are arranged in the short side direction X. The external shape of each of the electrode bodies 20a, 20b, and 20c is a flat shape. In another embodiment, however, the external shape of each of the electrode bodies 20a, 20b, and 20c may be a cylindrical shape or the like. Each of the electrode bodies 20a, 20b, and 20c is a wound electrode body here. The electrode bodies 20a, 20b, and 20c are disposed inside the battery case 10 with their winding axes WL (see FIG. 5) approximately parallel to the long side direction Y. An end surface of the electrode body 20a that is orthogonal to the winding axis WL (in other words, a stack surface where the positive electrode 22 and the negative electrode 24 are stacked) opposes the short side wall 12c.

FIG. 4 is a perspective view schematically illustrating the electrode body 20b. Although the electrode body 20b is described in detail below as an example, the electrode bodies 20a and 20c can also have the similar structure. The electrode body 20b has a pair of curved parts (R parts) 20r, and a flat part 20f coupling the pair of curved parts 20r. One curved part 20r (upper side in FIG. 4) opposes the sealing plate 14, and the other curved part 20r (lower side in FIG. 4) opposes the bottom wall 12a of the exterior body 12. The flat part 20f opposes the long side wall 12b of the exterior body 12. In the electrode bodies 20a, 20b, and 20c that are adjacent in the short side direction X, the respective flat parts 20f oppose each other.

FIG. 5 is a schematic view illustrating a structure of the electrode body 20b. The electrode body 20b includes the positive electrode 22, the negative electrode 24, and a separator 26. The electrode body 20b has a structure in which, here, the positive electrode 22 with a band shape and the negative electrode 24 with a band shape are stacked across the separator 26 with a band shape and wound using the winding axis WL as a center. The winding axis WL direction is approximately parallel to the long side direction Y. In another embodiment, the electrode body 20b may be a stack type electrode body formed in a manner that a plurality of square (typically, rectangular) positive electrodes and a plurality of square (typically, rectangular) negative electrodes are stacked in an insulated state.

The positive electrode 22 may be similar to the conventional positive electrode, without particular limitations. As illustrated in FIG. 5, the positive electrode 22 has a positive electrode core body 22c, and a positive electrode active material layer 22a and a positive electrode protection layer 22p that are fixed on at least one surface of the positive electrode core body 22c. The positive electrode protection layer 22p is not essential, and can be omitted in another embodiment. The positive electrode core body 22c has a band shape. The positive electrode core body 22c is preferably made of metal, and more preferably made of a metal foil. The positive electrode core body 22c is an aluminum foil here.

At one end part of the positive electrode core body 22c in the long side direction Y (left end part in FIG. 5), a plurality of positive electrode tabs 22t are provided. The positive electrode tabs 22t protrude toward one side in the long side direction Y (left side in FIG. 5). The positive electrode tabs 22t protrude in the long side direction Y more than the separator 26. The positive electrode tab 22t constitutes a part of the positive electrode core body 22c here, and is made of a metal foil (aluminum foil). The positive electrode tab 22t includes a part of the positive electrode core body 22c (core body exposed part) where the positive electrode active material layer 22a and the positive electrode protection layer 22p are not formed. As illustrated in FIG. 2 to FIG. 4, the positive electrode tabs 22t are stacked at one end part in the long side direction Y (left end part in FIG. 2 to FIG. 4), and form a positive electrode tab group 23. The positive electrode tab group 23 is electrically connected to the positive electrode terminal 30 through the positive electrode current collecting part 50. To the positive electrode tab group 23, a positive electrode second current collecting part 52, which is described below, is attached.

The positive electrode active material layer 22a is formed to have a band shape along a longitudinal direction of the positive electrode core body 22c as illustrated in FIG. 5. The positive electrode active material layer 22a includes a positive electrode active material that is capable of reversibly storing and releasing charge carriers. A lithium-transition metal complex oxide is preferably contained as the positive electrode active material. Specific examples include lithium cobaltate, lithium manganate, lithium nickelate, lithium-nickel-manganese complex oxides, lithium-nickel-cobalt complex oxides, lithium-nickel-cobalt-manganese complex oxides, and the like. Further, the positive electrode active material layer 22a may contain an optional component other than the positive electrode active material, such as a binder, a conductive material, or various additive components. As the binder, for example, polyvinylidene fluoride (PVdF) or the like can be used. As the conductive material, for example, a carbon material such as acetylene black (AB) can be used.

The positive electrode protection layer 22p is provided at a border part between the positive electrode core body 22c and the positive electrode active material layer 22a in the long side direction Y as illustrated in FIG. 5. The positive electrode protection layer 22p is provided to have a band shape along the positive electrode active material layer 22a. The positive electrode protection layer 22p contains inorganic filler (for example, alumina). The positive electrode protection layer 22p may contain an optional component other than the inorganic filler, such as a conductive material, a binder, or various additive components. The conductive material and the binder may be the same as those described as the examples that may be contained in the positive electrode active material layer 22a.

Although not particularly limited, a length (average length) La of the positive electrode active material layer 22a in the long side direction Y (also see FIG. 4) is preferably 20 cm or more and more preferably 25 cm or more in a high-capacity battery that may be used as an on-vehicle battery or the like. The length La in the long side direction Y is preferably 50 cm or less, and more preferably 40 cm or less. Usually, as the length La in the long side direction Y is longer, the nonaqueous electrolyte solution permeates less readily into the electrode body 20b, particularly in a central part thereof in the long side direction Y. Thus, it is particularly effective to apply the art disclosed herein.

As illustrated in FIG. 5, the negative electrode 24 has a negative electrode core body 24c, and a negative electrode active material layer 24a that is fixed on at least one surface of the negative electrode core body 24c. The negative electrode core body 24c has a band shape. The negative electrode core body 24c is preferably made of metal, and more preferably made of a metal foil. The negative electrode core body 24c is preferably made of copper, copper alloy, nickel, nickel alloy, or stainless steel, and more preferably made of copper or copper alloy. The negative electrode core body 24c is a copper foil here.

At one end part of the negative electrode core body 24c in the long side direction Y (right end part in FIG. 5), a plurality of negative electrode tabs 24t are provided. The negative electrode tabs 24t protrude toward one side in the long side direction Y (right side in FIG. 5). The negative electrode tabs 24t protrude in the long side direction Y more than the separator 26. The negative electrode tab 24t constitutes a part of the negative electrode core body 24c here, and is made of a metal foil (copper foil). The negative electrode tab 24t includes, here, a part of the negative electrode core body 24c (core body exposed part) where the negative electrode active material layer 24a is not formed. As illustrated in FIG. 2 to FIG. 4, the negative electrode tabs 24t are stacked at one end part in the long side direction Y (right end part in FIG. 2 to FIG. 4), and form a negative electrode tab group 25. The negative electrode tab group 25 is provided at a position that is symmetrical to the positive electrode tab group 23 in the long side direction Y. The negative electrode tab group 25 is electrically connected to the negative electrode terminal 40 through the negative electrode current collecting part 60. To the negative electrode tab group 25, a negative electrode second current collecting part 62, which is described below, is attached.

The negative electrode active material layer 24a is formed to have a band shape along a longitudinal direction of the negative electrode core body 24c as illustrated in FIG. 5. A length Ln of the negative electrode active material layer 24a in the long side direction Y is more than or equal to the length La of the positive electrode active material layer 22a in the long side direction Y. The negative electrode active material layer 24a includes a negative electrode active material that is capable of reversibly storing and releasing the charge carriers. The negative electrode active material has a particulate shape. The negative electrode active material is typically secondary particles (aggregated particles) each formed by an aggregation of primary particles, and has a space internally. Examples of the negative electrode active material include carbon materials such as natural graphite, artificial graphite, hard carbon, soft carbon, and amorphous carbon, a silicon-based material, and a mixture including any of the aforementioned materials. The negative electrode active material preferably contains graphite.

The negative electrode active material layer 24a may contain an optional component other than the negative electrode active material, such as a binder, a thickener, a dispersant, a conductive material, or various additive components. The negative electrode active material layer 24a preferably contains the binder. Examples of the usable binder include rubbers such as styrene butadiene rubber (SBR), an acrylic resin such as polyacrylic acid (PAA), and celluloses such as carboxymethyl cellulose (CMC). CMC can be used also as the thickener, the dispersant, or the like.

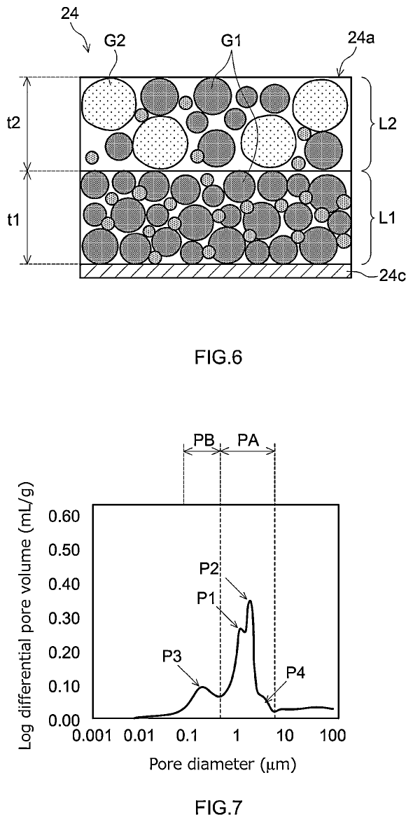

FIG. 6 is a cross-sectional view schematically illustrating a structure of the negative electrode 24. As illustrated in FIG. 6, the negative electrode active material layer 24a has a multilayer structure here. Specifically, the negative electrode active material layer 24a has a two-layer structure including a negative electrode lower layer L1 close to the negative electrode core body 24c, and a negative electrode upper layer L2 farther from the negative electrode core body 24c than the negative electrode lower layer L1. The negative electrode upper layer L2 exists on a surface side compared to the negative electrode lower layer L1, and here, forms an outermost layer of the negative electrode active material layer 24a.

The negative electrode lower layer L1 is a portion having relatively higher packing density than the negative electrode upper layer L2, and contributing to the higher energy density of the battery. In the negative electrode lower layer L1, pores corresponding to a first peak P1, which is described below, exist. The packing density of the negative electrode lower layer L1 is typically higher than that of the negative electrode upper layer L2, and is preferably 1.51 g/cm³ or more, more preferably 1.54 g/cm³ or more, and still more preferably 1.58 g/cm³ or more from the viewpoint of increasing the energy density. Note that, in this specification, “packing density” is expressed by packing density (g/cm³)=layer mass/layer volume and refers to the mass of the component included per unit volume of the layer including a space part (for example, this component corresponds to the total of the negative electrode active material and the optional component such as the binder) (this also applies to the description below). A thickness (average thickness) t1 of the negative electrode lower layer L1 is preferably 39.1 μm or less, more preferably 38.2 μm or less, and still more preferably 37.4 μm or less.

The negative electrode lower layer L1 preferably includes first graphite particles G1 as the negative electrode active material. The first graphite particle G1 is preferably natural graphite (for example, highly spheroidized natural graphite). Since natural graphite can be easily packed and is crushed less easily even when being packed densely, natural graphite can suitably secure the internal space in the negative electrode lower layer L1. The first graphite particle G1 may have a coat layer formed of amorphous carbon on a surface thereof. In the negative electrode lower layer L1, the mass of the first graphite particles G1 to the total mass of the negative electrode active material is preferably 80 mass % or more, more preferably 90 mass % or more, and still more preferably 95 mass % or more. It is preferable that the negative electrode lower layer L1 does not include second graphite particles G2, which are described below, or the mass of the second graphite particles G2 to the total mass of the negative electrode active material is less than 5 mass %.

An average particle diameter (D50) of the first graphite particles G1 is preferably smaller than an average particle diameter (D50) of the second graphite particles G2, which are described below. The average particle diameter (D50) of the first graphite particles G1 is generally 1 to 10 μm, typically 2 to 5 μm, and preferably 2.18 to 2.63 μm, for example. The particle size distribution width of the first graphite particles G1 is preferably larger than that of the second graphite particles G2. The first graphite particles G1 preferably has a particle size distribution width of 3.73 to 4.87. The term “particle size distribution width” in this specification refers to a value obtained by (D90−D10)/D50 (in which D10, D50, and D90 represent the particle diameters at which the cumulative value corresponds to 10%, 50%, and 90%, respectively, in the particle diameter distribution based on the number of particles in the measurement with a laser diffraction/scattering particle size distribution meter) (this also applies to the description below).

The tap density of the first graphite particles G1 is preferably larger than that of the second graphite particles G2, which are described below. The tap density of the first graphite particles G1 is preferably 1.10 to 1.20 g/cm³. The term “tap density” in this specification refers to the apparent bulk density obtained from the apparent volume when 50 g of a sample (powder) is input into a graduated cylinder and the graduated cylinder is tapped 1000 times to pack the sample densely.

The negative electrode upper layer L2 is a portion having relatively lower packing density than the negative electrode lower layer L1 and being excellent in impregnation with the nonaqueous electrolyte solution. The negative electrode upper layer L2 is a portion with relatively high wettability to the nonaqueous electrolyte solution. In the negative electrode upper layer L2, pores corresponding to a second peak P2, which is described below, exist. The packing density of the negative electrode upper layer L2 is typically lower than that of the negative electrode lower layer L1, and is preferably 1.39 g/cm³ or less, more preferably 1.36 g/cm³ or less, and still more preferably 1.33 g/cm³ or less from the viewpoint of improving the impregnation with the nonaqueous electrolyte solution. The ratio of the packing density of the negative electrode lower layer L1 to that of the negative electrode upper layer L2 is preferably 1.09 or more, more preferably 1.13 or more, and still more preferably 1.18 or more.

The negative electrode upper layer L2 may be a portion with relatively more pores and/or with larger pore diameter (gap between particles) than the negative electrode lower layer L1. A thickness (average thickness) t2 of the negative electrode upper layer L2 is preferably 42.4 μm or more, more preferably 43.3 μm or more, and still more preferably 44.1 μm or more. A ratio (t1/t2) of the thickness t1 of the negative electrode lower layer L1 to the thickness t2 of the negative electrode upper layer L2 is preferably 1.09 to 1.18, and more preferably 1.13 to 1.18.

The negative electrode upper layer L2 preferably includes the second graphite particles G2 in addition to the aforementioned first graphite particles G1 as the negative electrode active material. The second graphite particle G2 is different from the first graphite particle G1 described above in at least one of the kind and the property (for example, shape, average particle diameter, tap density, or the like). The second graphite particle G2 is preferably artificial graphite. The second graphite particle G2 may have a coat layer formed of amorphous carbon on a surface thereof. In the negative electrode upper layer L2, the mixing ratio between the first graphite particle G1 and the second graphite particle G2 is preferably 8:2 to 6:4, and more preferably 7:3 to 6:4 in mass ratio.

The average particle diameter (D50) of the second graphite particles G2 is preferably larger than the average particle diameter (D50) of the first graphite particles G1. The average particle diameter (D50) of the second graphite particles G2 is generally 2 to 20 μm, typically 5 to 15 μm, and preferably 8.85 to 10.68 μm, for example. The particle size distribution width of the second graphite particles G2 is preferably smaller than that of the first graphite particles G1. The particle size distribution width of the second graphite particles G2 is preferably 0.90 to 3.59. The tap density of the second graphite particles G2 is preferably smaller than that of the first graphite particles G1. The tap density of the second graphite particles G2 is preferably 0.93 to 1.09 g/cm³. By satisfying at least one of the average particle diameter, the particle size distribution width, and the tap density described above, the packing density of the negative electrode upper layer L2 can be adjusted to be smaller than that of the negative electrode lower layer L1, so that the charging density can have suitable bias in the negative electrode active material layer 24a. As a result, the impregnation with the nonaqueous electrolyte solution can be improved as appropriate.

FIG. 7 illustrates one example of a Log differential pore volume distribution of the negative electrode active material layer 24a obtained by a mercury intrusion method. In the Log differential pore volume distribution, the pore diameter distribution is expressed by a graph in which the horizontal axis represents the pore diameter (μm) and the vertical axis represents the Log differential pore volume (mL/g). As illustrated in FIG. 7, the negative electrode active material layer 24a has the first peak P1 and the second peak P2, which exists on the side where the pore diameter is larger than that at the first peak P1, in a range PA (indicated by dashed lines in FIG. 7) where the pore diameter is 0.50 to 6.00 μm. Note that a peak position is determined based on the position of a peak top. The peak that appears in the range PA corresponds to gaps between the particles in the negative electrode active material layer 24a mainly. The Log differential pore volume distribution has a valley part, where the value becomes small once, between the first peak P1 and the second peak P2. The first peak P1 and the second peak P2, however, do not need to be separated completely. The first peak P1 and the second peak P2 more preferably exist in the range where the pore diameter is 0.45 to 3.00 μm. The range PA may alternatively have three or more peaks, which will be described below.

The first peak P1 is a peak derived from the gaps between the particles in the negative electrode lower layer L1 here. The first peak P1 (that is, the average diameter of the gaps between the particles in the negative electrode lower layer L1) is preferably 1.31 μm or less, and more preferably 1.21 μm or less. A pore volume V1 of pores, which correspond to the first peak P1, corresponds to the pore volume of the gaps between the particles in the negative electrode lower layer L1 here. In the present embodiment, the pore volume V1 is 6 mL/g or more. Thus, the nonaqueous electrolyte solution can spread throughout the negative electrode lower layer L1 using a capillary phenomenon. Accordingly, the impregnation of the negative electrode active material layer 24a with the nonaqueous electrolyte solution can be improved. The pore volume V1 is more preferably 6.5 mL/g or more. The pore volume V1 is preferably 8.71 mL/g or less, more preferably 7.8 mL/g or less, and still more preferably 6.68 mL/g or less.

The second peak P2 is a peak derived from the gaps between the particles in the negative electrode upper layer L2 here. The second peak P2 (that is, the average diameter of the gaps between the particles in the negative electrode upper layer L2) is larger than the first peak P1, preferably 1.74 μm or more, and more preferably 1.81 μm or more. Thus, the contact angle on the nonaqueous electrolyte solution can be reduced and the wettability of the negative electrode upper layer L2 can be improved. Accordingly, the impregnation of the negative electrode active material layer 24a with the nonaqueous electrolyte solution can be improved. A pore volume V2 of the pores, which correspond to the second peak P2, corresponds to the pore volume of the gaps between the particles in the negative electrode upper layer L2 here. The pore volume V2 is preferably 2 mL/g or more. The pore volume V2 is preferably 2.51 mL/g or more, more preferably 4.31 mL/g or more, and still more preferably 5.47 mL/g or more from the viewpoint of improving the wettability.

An intensity A at the first peak P1 and an intensity B at the second peak P2 preferably satisfy the following relation: A/B=0.5 to 1.5. The intensity B at the second peak P2 is preferably larger than the intensity A at the first peak P1 (that is, A<B). Thus, the negative electrode lower layer L1 and the negative electrode upper layer L2 can be balanced and the effect of the art disclosed herein can be obtained at a higher level.

As illustrated in FIG. 7, in the present embodiment, the negative electrode active material layer 24a additionally has a third peak P3 in a range PB where the pore diameter is 0.10 to 0.50 μm in the Log differential pore volume distribution. The third peak P3 exists on the side where the diameter is smaller than that at the first peak P1. The peak that appears in the range PB corresponds to the gaps in the negative electrode active material particles (secondary particles) mainly. The third peak P3 is a peak derived from the pores inside the graphite particles, for example. An intensity C at the third peak P3 is smaller than the intensity A at the first peak P1 and the intensity B at the second peak P2. The intensity A at the first peak P1 and the intensity C at the third peak P3 preferably satisfy the following relation: A/C=3.0 to 3.3. Accordingly, the impregnation of the negative electrode active material layer 24a can be improved further.

In the present embodiment, the negative electrode active material layer 24a further has a fourth peak P4 on the side where the pore diameter is larger than that at the second peak P2 in the range PA in the Log differential pore volume distribution. The fourth peak P4 is a peak derived from the second graphite particles G2 (for example, artificial graphite) included in the negative electrode upper layer L2 here.

Referring back to FIG. 5, the separator 26 is disposed between the positive electrode 22 and the negative electrode 24. The separator 26 is a member that insulates between the positive electrode active material layer 22a of the positive electrode 22 and the negative electrode active material layer 24a of the negative electrode 24. A length Ls of the separator 26 in the long side direction Y is longer than or equal to the length Ln of the negative electrode active material layer 24a in the long side direction Y. The separator 26 is suitably a porous sheet made of resin including polyolefin resin such as polyethylene (PE) or polypropylene (PP). The separator 26 may include a base material layer formed of a porous sheet made of resin, and an adhesive layer including a binder and formed on at least one surface of the base material layer. In this case, the separator 26 is preferably attached to at least one of the positive electrode 22 and the negative electrode 24 through the adhesive layer.

As illustrated in FIG. 2, the positive electrode current collecting part 50 forms a conductive path for electrically connecting the positive electrode terminal 30 and the positive electrode tab group 23 formed by the positive electrode tabs 22t. The positive electrode current collecting part 50 includes a positive electrode first current collecting part 51 and a positive electrode second current collecting part 52. The positive electrode first current collecting part 51 and the positive electrode second current collecting part 52 may be formed of the same metal species as the positive electrode core body 22c, for example, a conductive metal such as aluminum, aluminum alloy, nickel, or stainless steel.

The positive electrode first current collecting part 51 is attached to an inner surface of the sealing plate 14. The positive electrode first current collecting part 51 is fixed to the sealing plate 14 by the caulking process here. The positive electrode first current collecting part 51 includes a first region extending horizontally along the inner surface of the sealing plate 14, and a second region extending from one end (left end in FIG. 2) of the first region in the long side direction Y to the short side wall 12c of the exterior body 12. In the first region, a penetration hole (not shown) penetrating in the up-down direction Z is formed at a position in the sealing plate 14 that corresponds to the terminal extraction hole 18. The first region is electrically connected to the positive electrode terminal 30 by the caulking process. The first region is insulated from the sealing plate 14 by the internal insulation member 80. The second region extends along the up-down direction Z.

The positive electrode second current collecting part 52 extends along the short side wall 12c of the exterior body 12. As illustrated in FIG. 3 and FIG. 4, the positive electrode second current collecting part 52 is attached to the electrode body 20b. The positive electrode second current collecting part 52 includes a current collecting plate connection part 52a that is electrically connected to the second region of the positive electrode first current collecting part 51, a tab joint part 52c that is attached to the positive electrode tab group 23 and electrically connected to the positive electrode tabs 22t, and a coupling part 52b that couples the current collecting plate connection part 52a and the tab joint part 52c.

The current collecting plate connection part 52a extends along the up-down direction Z. In the current collecting plate connection part 52a, a concave part 52d that is thinner than its periphery is provided. In the concave part 52d, a penetration hole 52e that penetrates in the short side direction X is provided. In the penetration hole 52e, a joint part with the positive electrode first current collecting part 51 is formed. The joint part is, for example, a welding joint part formed by welding such as ultrasonic welding, resistance welding, or laser welding. The tab joint part 52c extends in the up-down direction Z. In the tab joint part 52c, a joint part with the positive electrode tab group 23 is formed. The joint part is, for example, a welding joint part formed by welding such as ultrasonic welding, resistance welding, or laser welding while the positive electrode tabs 22t are stacked on each other.

As illustrated in FIG. 2, the negative electrode current collecting part 60 forms a conductive path for electrically connecting the negative electrode terminal 40 and the negative electrode tab group 25 formed by the negative electrode tabs 24t. The negative electrode current collecting part 60 includes a negative electrode first current collecting part 61 and a negative electrode second current collecting part 62. The negative electrode first current collecting part 61 and the negative electrode second current collecting part 62 may be formed of the same metal species as the negative electrode core body 24c, for example, a conductive metal such as copper, copper alloy, nickel, or stainless steel. The negative electrode first current collecting part 61 and the negative electrode second current collecting part 62 may have structures similar to those of the positive electrode first current collecting part 51 and the positive electrode second current collecting part 52 of the positive electrode current collecting part 50, respectively.

As illustrated in FIG. 4, the negative electrode second current collecting part 62 includes a current collecting plate connection part 62a that is electrically connected to the negative electrode first current collecting part 61, a tab joint part 62c that is attached to the negative electrode tab group 25 and electrically connected to the negative electrode tabs 24t, and a coupling part 62b that couples the current collecting plate connection part 62a and the tab joint part 62c. In the current collecting plate connection part 62a, a concave part 62d to be coupled to the tab joint part 62c is provided. In the concave part 62d, a penetration hole 62e that penetrates in the short side direction X is provided.

The secondary battery 100 is usable in various applications, and for example, can be suitably used as a motive power source for a motor (power source for driving) that is mounted in a vehicle such as a passenger car or a truck. The vehicle is not limited to a particular type, and may be, for example, a plug-in hybrid electric vehicle (PHEV), a hybrid electric vehicle (HEV), or a battery electric vehicle (BEV).

Some examples of the present invention are hereinafter described but these examples are not intended to limit the present invention to the examples below.

[Manufacture of Negative Electrode]
(Example 1) First, the following two kinds of negative electrode active material (first graphite particles and second graphite particles) were prepared. The first graphite particles are natural graphite with a tap density of 1.11 g/cm³, an average particle diameter (D50) of 2.38 μm, and a particle size distribution width (D90−D10)/D50 of 3.94. The second graphite particles are artificial graphite with a tap density of 1.04 g/cm³, an average particle diameter (D50) of 9.68 μm, and a particle size distribution width (D90−D10)/D50 of 1.13. Next, 98.5 parts by mass of the first graphite particles, 0.5 parts by mass of CMC (sodium salt), and 1 part by mass of SBR were mixed and a suitable amount of water was added thereto, and thus a first slurry for negative electrode lower layer formation was prepared. Next, the first graphite particles and the second graphite particles were mixed in a mass ratio of 6:4, and thus a mixed active material was manufactured. Next, 98.5 parts by mass of the mixed active material, 0.5 parts by mass of CMC (sodium salt), and 1 part by mass of SBR were mixed and a suitable amount of water was added thereto, and thus a second slurry for negative electrode upper layer formation was prepared.

Next, the first slurry was applied on both surfaces of the negative electrode core body, which was formed of a copper foil, except a part (tab) to which a lead was to be connected, and the applied film was dried; thus, a first layer (negative electrode lower layer) was formed on both surfaces of the negative electrode core body. Next, on both surfaces of the negative electrode core body, on which the first layer was formed, the second slurry was applied and the applied film was dried; thus, a second layer (negative electrode upper layer) was formed. Note that the weight ratio between the negative electrode lower layer and the negative electrode upper layer of the completed negative electrode active material layer was 1:1. After that, the negative electrode active material layer was compressed using a roller so that the electrode density became 1.45 g/cm³, and then cut into a predetermined electrode size. Thus, the negative electrode in which the negative electrode active material layer including the negative electrode lower layer and the negative electrode upper layer was formed on both surfaces of the negative electrode core body was manufactured. Table 1 shows the packing density and the thickness of each layer.
(Example 2) A negative electrode was manufactured in a manner similar to Example 1 except that the mixed active material in which the first graphite particles and the second graphite particles were mixed in a mass ratio of 7:3 was used in the preparation of the second slurry. Table 1 shows the packing density and the thickness of each layer.
(Example 3) A negative electrode was manufactured in a manner similar to Example 1 except that the mixed active material in which the first graphite particles and the second graphite particles were mixed in a mass ratio of 8:2 was used in the preparation of the second slurry. Table 1 shows the packing density and the thickness of each layer.
(Comparative Example 1) A negative electrode was manufactured in a manner similar to Example 1 except that the negative electrode active material layer with a single-layer structure was formed on both surfaces of the negative electrode core body using only the first slurry. Table 1 shows the packing density and the thickness of the layer.
(Comparative Example 2) A negative electrode was manufactured in a manner similar to Example 1 except that the negative electrode active material layer with the single-layer structure was formed on both surfaces of the negative electrode core body using only the second slurry. Table 1 shows the packing density and the thickness of the layer.
(Comparative Example 3) A negative electrode was manufactured in a manner similar to Example 1 except that the negative electrode lower layer was formed using the second slurry and the negative electrode upper layer was formed using the first slurry, which is opposite to Example 1. Table 1 shows the packing density and the thickness of each layer.
(Comparative Example 4) A negative electrode was manufactured in a manner similar to Example 1 except that the mixed active material in which the first graphite particles and the second graphite particles were mixed in a mass ratio of 5:5 was used in the preparation of the second slurry. Table 1 shows the packing density and the thickness of each layer.

[Measurement and Analysis of Pore Distribution]

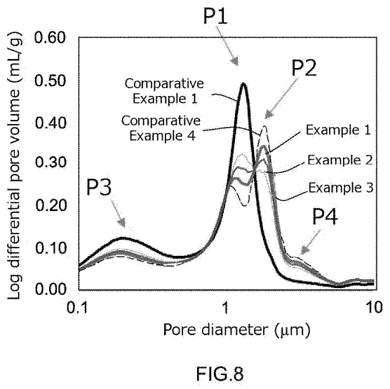

The pore distributions of the manufactured negative electrodes (Examples 1 to 3, and Comparative Examples 1 to 4) were measured. Specifically, the pore distribution was measured by the mercury intrusion method using AutoPore IV 9500 (manufactured by Micrometrics) as a pore distribution measurement apparatus. Note that the mercury contact angle was set to 140.0° and the mercury surface tension was set to 480.0 dynes/cm as the mercury parameters. Then, the Log differential pore volume distribution was obtained using the software that belongs to the measurement apparatus. As representative examples, FIG. 8 expresses the Log differential pore volume distributions in Examples 1 to 3, and Comparative Examples 1 and 4.

Next, regarding each Log differential pore volume distribution, whether the first peak P1, the second peak P2, and the fourth peak P4 described above appeared in the range where the pore diameter was 0.50 to 6.00 μm was checked. Note that the first peak P1 is the peak derived from the gaps between the particles in the negative electrode lower layer. The second peak P2 is the peak derived from the gaps between the particles in the negative electrode upper layer. The fourth peak P4 is the peak derived from the artificial graphite included in the negative electrode upper layer. Then, the values of the first peak P1 and the second peak P2 in the horizontal axis, that is, the average diameters of the gaps between the particles are read and shown in the column “diameter” in the respective layers in Table 1. Moreover, the pore volume of the pores at each of the first peak P1 and the second peak P2 is calculated and shown as the pore volume of the gaps between the particles in each layer in Table 1. The values of the first peak P1 and the second peak P2 in the vertical axis, that is, the modes of the pore volumes of the respective layers were regarded as the peak intensities, and the ratio (intensity ratio) of the intensity B of the second peak P2 to the intensity A of the first peak P1 was calculated. The results are shown in Table 1. Moreover, whether the third peak P3 described above appeared in the range where the pore diameter was 0.10 to 0.50 μm was checked. Note that the third peak P3 is the peak derived from the pores in the negative electrode active material particles. The results are shown in Table 1.

[Measurement of Impregnation]

The manufactured negative electrodes (Examples 1 to 3, and Comparative Examples 1 to 4) were each punched into a circular shape, and thus samples were obtained. Next, 1 μL of liquid simulating the nonaqueous electrolyte solution, which was polycarbonate (PC) here, was injected to a center on the sample using a micro-syringe, and the time it took for the liquid to permeate into the sample was measured. By dividing the amount of injected PC by the time it took to permeate into the sample, the liquid absorbing speed (μL/s) was calculated. The results are shown in Table 1. The columns in the evaluation in Table 1 show a circular mark when the liquid absorbing speed is 0.05 μL/s or more and a cross mark when the liquid absorbing speed is less than 0.05 μL/s.

TABLE 1

| | First layer (negative electrode lower layer) L1 | | | | | Second layer (negative electrode upper layer) L2 | | | | |
|---|---|---|---|---|---|---|---|---|---|---|
| | First | | | | | First | | | | |
| | graphite | | P1 | | | graphite | | P2 | | |
| | particle: | | Pore | | | particle: | | Pore | | |
| | second | | volume | | | second | | volume | | |
| | graphite | | of gaps | | | graphite | | of gaps | | |
| | particle | Packing | between | P1 | | particle | Packing | between | P2 | |
| | (mass | density | particles | Diameter | Thickness | (mass | density | particles | Diameter | Thickness |
| | ratio) | (g/cm³) | (mL/g) | (μm) | (μm) | ratio) | (g/cm³) | (mL/g) | (μm) | (μm) |
| Example 1 | 10:0 | 1.58 | 6.68 | 1.21 | 37.4 | 5:4 | 1.33 | 5.47 | 1.81 | 44.1 |
| Example 2 | 10:0 | 1.54 | 7.80 | 1.21 | 38.2 | 7:3 | 1.36 | 4.31 | 1.81 | 43.3 |
| Example 3 | 10:0 | 1.51 | 8.71 | 1.31 | 39.1 | 8:2 | 1.39 | 2.51 | 1.74 | 42.4 |
| Comparative | 10:0 | 1.45 | 11.91 | 1.31 | 81.6 | — | | | | |
| Example 1 | | | | | | | | | | |
| Comparative | — | | | | | 6:4 | 1.45 | 12.41 | 1.38 | 81.6 |
| Example 2 | | | | | | | | | | |
| Comparative | 6:4 | 1.33 | 12.19 | 1.34 | 44.1 | 10:0 | 1.58 | N.D. | 1.34 | 37.4 |
| Example 3 | | | | | | | | | | |
| Comparative | 10:0 | 1.61 | 5.68 | 1.08 | 36.5 | 5:5 | 1.30 | 6.52 | 1.79 | 45.0 |
| Example 4 | | | | | | | | | | |
| | | | | | | | Intensity | | | |
| | | | | | | | between | | | |
| | | | | | | A | P1 and | | Impregnation | |
| | | | | | | < | P2 | | | absorbing Liquid |
| | | | P3 | P1 | P2 | B | ratio B/A | P4 | Evaluation | speed (μL/s) |
| | | Example 1 | Exists | Exists | Exists | O | 1.30 | Exists | O | 0.059 |
| | | Example 2 | Exists | Exists | Exists | O | 1.07 | Exists | O | 0.058 |
| | | Example 3 | Exists | Exists | Exists | X | 0.86 | Exists | O | 0.055 |
| | | Comparative | Exists | Exists | Does | — | | Does | X | 0.043 |
| | | Example 1 | | | not | | | not | | |
| | | | | | exist | | | exist | | |
| | | Comparative | Exists | Exists | Does | — | | Exists | X | 0.045 |
| | | Example 2 | | | not | | | | | |
| | | | | | exist | | | | | |
| | | Comparative | Exists | Exists | N.D. | — | | Exists | X | 0.049 |
| | | Example 3 | | | | | | | | |
| | | Comparative | Exists | Exists | Exists | O | 1.58 | Exists | X | 0.047 |
| | | Example 4 | | | | | | | | |

* N.D. in this table indicates that a clear peak was not confirmed (the value is less than or equal to a measurement lower limit value).

Table 1 indicates that Examples 1 to 3 in which the Log differential pore volume distribution has the first peak P1 and the second peak P2, which exists on the side where the pore diameter is larger than that at the first peak P1, in the range where the pore diameter is 0.50 to 6.00 μm and the pore volume of the pores corresponding to the first peak P1 is 6 mL/g or more are superior to Comparative Examples 1 to 4 because the liquid absorbing speed is higher and the impregnation with the nonaqueous electrolyte solution is superior. Comparative Example 2 indicates that simply mixing the first negative electrode active material and the second negative electrode active material cannot achieve the aforementioned pore distribution, and the pore distribution as described above can be suitably achieved when the negative electrode active material layer has the multilayer structure in which the negative electrode lower layer includes only the first graphite particles and the negative electrode upper layer includes the first graphite particles and the second graphite particles, and the properties of the respective layers are adjusted as appropriate as described in Examples 1 to 3, for example.

Although not particularly limited, the present inventors consider the following mechanism as to the reason why the liquid absorbing speed has improved in Examples 1 to 3. According to the present inventors' examination, in a case where the negative electrode active material layer is impregnated with the nonaqueous electrolyte solution using the capillary phenomenon, the nonaqueous electrolyte solution spreads faster and farther as the pore diameter is smaller. On the other hand, when the amount of spaces in the negative electrode active material layer becomes too small, the contact angle increases, and in this case, the wettability deteriorates, making it difficult for the nonaqueous electrolyte solution to permeate.

In view of this, in the present embodiment, the packing density is increased and the pore diameter is decreased in the negative electrode lower layer, and meanwhile, the packing density is decreased and the pore diameter is increased in the negative electrode upper layer.

Accordingly, the Log differential pore volume distribution can suitably have the two peaks with the different sizes (specifically, the first peak P1 derived from the gaps between the particles in the negative electrode lower layer, and the second peak P2 derived from the gaps between the particles in the negative electrode upper layer) in the range corresponding to the gaps between the particles in the negative electrode active material layer mainly, that is, in the range where the pore diameter is 0.50 to 6.00 μm. As a result, in the negative electrode lower layer, the nonaqueous electrolyte solution can spread fast to the inside of the negative electrode active material layer using the capillary phenomenon. In the negative electrode upper layer, the wettability can be improved by increasing the amount of spaces and reducing the contact angle on the nonaqueous electrolyte solution. Thus, the liquid absorbing speed of the nonaqueous electrolyte solution can be improved and the impregnation of the negative electrode active material layer with the nonaqueous electrolyte solution can be improved. Although the detailed description is omitted, the increase in affinity to the nonaqueous electrolyte solution can form a high-quality film on the surface of the negative electrode active material so as to improve the battery characteristic (for example, at least one of cycle characteristic, preservation characteristic, and durability).

Although some embodiments of the present invention have been described above, they are merely examples. The present invention can be implemented in various other modes. The present invention can be implemented based on the contents disclosed in this specification and the technical common sense in the relevant field. The techniques described in the scope of claims include those in which the embodiments exemplified above are variously modified and changed. For example, a part of the aforementioned embodiment can be replaced by another modified example, and the other modified example can be added to the aforementioned embodiment. Additionally, the technical feature may be deleted as appropriate unless such a feature is described as an essential element.

### REFERENCE SIGNS LIST

20 Electrode body group
20a, 20b, 20c Electrode body
22 Positive electrode
22a Positive electrode active material layer
22c Positive electrode core body
24 Negative electrode
24a Negative electrode active material layer
L1 Negative electrode lower layer
L2 Negative electrode upper layer
24c Negative electrode core body
100 Secondary battery

What is claimed is:

1. A secondary battery comprising:
an electrode body including a positive electrode and a negative electrode;
a nonaqueous electrolyte solution; and
a battery case that accommodates the electrode body and the nonaqueous electrolyte solution, wherein
the negative electrode includes a negative electrode core body, and a negative electrode active material layer formed on the negative electrode core body and including a negative electrode active material,
the negative electrode active material layer has, in a Log differential pore volume distribution obtained by a mercury intrusion method, a first peak and a second peak with a larger pore diameter than the first peak in a range where a pore diameter is 0.50 μm or more and 6.00 μm or less, and
a pore volume of pores corresponding to the first peak is 6 mL/g or more.

2. The secondary battery according to claim 1, wherein
the electrode body is a flat-shaped wound electrode body in which the positive electrode with a band shape and the negative electrode with a band shape are wound across a separator with a band shape, and
the positive electrode has a width of 20 cm or more in a winding axis direction.

3. The secondary battery according to claim 1, wherein an intensity A at the first peak and an intensity B at the second peak satisfy A/B=0.5 to 1.5.

4. The secondary battery according to claim 1, wherein an intensity B at the second peak is larger than an intensity A at the first peak.

5. The secondary battery according to claim 1, wherein
the negative electrode active material layer additionally has, in the Log differential pore volume distribution obtained by the mercury intrusion method, a third peak in a range where the pore diameter is 0.10 μm or more and 0.50 μm or less, and
the third peak has a smaller pore diameter than the first peak.

6. The secondary battery according to claim 1, wherein the negative electrode active material layer additionally has, in the Log differential pore volume distribution obtained by the mercury intrusion method, a fourth peak with a larger pore diameter than the second peak in the range where the pore diameter is 0.50 μm or more and 6.00 μm or less.

7. The secondary battery according to claim 1, wherein
the negative electrode active material layer includes a negative electrode lower layer close to the negative electrode core body, and a negative electrode upper layer farther from the negative electrode core body than the negative electrode lower layer,
the pores corresponding to the first peak exist in the negative electrode lower layer, and
the pores corresponding to the second peak exist in the negative electrode upper layer.

8. The secondary battery according to claim 7, wherein the negative electrode lower layer has higher packing density than the negative electrode upper layer.

9. The secondary battery according to claim 7, wherein a ratio of a thickness of the negative electrode lower layer to a thickness of the negative electrode upper layer is 1.09 to 1.18.

10. The secondary battery according to claim 7, wherein
the negative electrode lower layer includes first graphite particles as the negative electrode active material,
a mass of the first graphite particles is 80 mass % or more to a total mass of the negative electrode active material included in the negative electrode lower layer,
the negative electrode upper layer includes the first graphite particles and second graphite particles,
a mixing ratio between the first graphite particles and the second graphite particles included in the negative electrode upper layer is 8:2 to 6:4 in a mass ratio, and
an average particle diameter (D50) of the second graphite particles is larger than an average particle diameter (D50) of the first graphite particles.

11. The secondary battery according to claim 10, wherein the first graphite particles have higher tap density than the second graphite particles.

12. The secondary battery according to claim 10, wherein
a particle size distribution width of the first graphite particles is larger than a particle size distribution width of the second graphite particles, and
the particle size distribution width refers to a value expressed by (D90−D10)/D50 (in which D10, D50, and D90 represent particle diameters at which cumulative values correspond to 10%, 50%, and 90%, respectively in a particle size distribution based on the number of particles).

13. The secondary battery according to claim 10, wherein
the first graphite particles have a tap density of 1.10 g/cm³ or more and 1.20 g/cm³ or less,
the first graphite particles have a particle size distribution width of 3.73 to 4.87, and
the particle size distribution width refers to a value expressed by (D90−D10)/D50 (in which D10, D50, and D90 represent particle diameters at which cumulative values correspond to 10%, 50%, and 90%, respectively in a particle size distribution based on the number of particles).

14. The secondary battery according to claim 10, wherein
the second graphite particles have a tap density of 0.93 g/cm³ or more and 1.09 g/cm³ or less,
the second graphite particles have a particle size distribution width of 0.90 to 3.59, and
the particle size distribution width refers to a value expressed by (D90−D10)/D50 (in which D10, D50, and D90 represent particle diameters at which cumulative values correspond to 10%, 50%, and 90%, respectively in a particle size distribution based on the number of particles).
